(19) United States
(12) Patent Application Publication
(10) Pub. No.: US 2005/0071753 A1
(43) Pub. Date: Mar. 31, 2005

(54) Variable size input areas in user interfaces

(76) Inventors: Udo Klein, Maximiliansau (DE); Uwe Klinger, Bad Schoenborn (DE); Martin Scholz, Nussloch (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/675,208

(22) Filed: Sep. 30, 2003

(51) Int. Cl. G06F 17/21

(52) U.S. Cl. 715/508; 715/504

(57) ABSTRACT

Variable size user input areas that visually indicate an amount of characters that can be entered into a corresponding data field. A method involves displaying a user input area within a computer user interface wherein the user input area corresponds to a data field having a specified number of characters. The user input area is displayed having a size that visually indicates to a user that the user input area will accommodate therein visual representations of the specified number of characters. Upon receipt of a user input specifying a character to be included in the data field, a visual representation of the input character in a proportional font is displayed within the user input area. The user input area is displayed having a size that visually indicates to the user that the user input area will accommodate therein visual representations of a remaining number of the specified number of characters.

### TECHNICAL FIELD

The invention relates to variable size user input areas in computer user interfaces.

### BACKGROUND

User interfaces typically provide input areas for users to enter data for data fields in the underlying software. The input area has a particular size when displayed on the computer screen. For a typical rectangular input area, the screen size consists of a respective height and length of the user input area.

The input area screen size is, however, distinct from the amount of information that can be entered in the corresponding data field. With the use of scrolling functions, for example, the data input (such as characters) can be greater than the visible length of the scrollable field. Similarly, regardless of its screen size, a field may limit the amount of data that can be input, such as is sometimes done with U.S. zip code fields. Thus, even if a zip code field appears capable of accepting any amount of data, the input may be restricted to five characters.

If the user interface program (or the underlying software application) does not limit the amount of input data, the user could enter a virtually endless string of characters into the input area. But it is seldom useful to be able to enter so much information for a single data field, and in most circumstances the data field is limited to a certain number of characters. This is usually the case in applications where the user enters data into a form, analogous to manually filling out a paper form.

Attempts have been made to inform the user how much data can be entered in the field. First, a static text string may indicate that the field accepts a “maximum 15 characters” or words to that effect. There is no dynamic feedback that depends on the amount of data entered in the field.

Second, it is possible to have an on-screen counter that counts down the remaining characters that can be input into the field. For example, as the user types characters, the counter—perhaps at the bottom of the screen—displays sequential messages that the remaining number of characters is 5, 4, and so on. A problem with this approach is that it requires the user to read a number outside the field to learn how much data that can still be input into the field.

The use of proportional fonts also complicates the feedback to the user. Because the characters in a proportional font have different widths, the total width of a character string is not determined merely by the number of characters; it depends on which the characters are. For example, the “W” character is much wider than the “i” character. Thus, if a data field has a fixed length, an input area with a fixed screen size does not indicate to the user how much data can be input using proportional font characters.

### SUMMARY

The invention relates to variable length input areas in user interfaces.

In a first general aspect, the invention provides a method of displaying a user input area within a computer user interface wherein the user input area corresponds to a data field having a specified number of characters. The method comprises displaying the user input area having a size that visually indicates to a user that the user input area will accommodate therein visual representations of the specified number of characters. Upon receipt of a user input specifying a character to be included in the data field, the method comprises displaying within the user input area a visual representation of the input character in a proportional font. The user input area is displayed having a size that visually indicates to the user that the user input area will accommodate therein visual representations of a remaining number of the specified number of characters.

In selected embodiments, the size of the user input area after displaying the specified character equals a width of the specified character plus the remaining number of the specified number of characters times a selected character width.

In selected embodiments, the user input area may be adjusted differently after a second last character of the specified number of characters is received. The user input area may then be adjusted to equal a width of all characters in the user input area plus a maximum width of characters.

In a second general aspect, the invention provides a computer program product containing executable instructions for displaying a user input area within a computer user interface wherein the user input area corresponds to a data field having a specified number of characters. When executed, the instructions cause a processor to:
display the user input area having a size that visually indicates to a user that the user input area will accommodate therein visual representations of the specified number of characters;
upon receipt of a user input specifying a character to be included in the data field, display within the user input area a visual representation of the input character in a proportional font; and
display the user input area having a size that visually indicates to the user that the user input area will accommodate therein visual representations of a remaining number of the specified number of characters.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a computer system capable of displaying variable size user input areas;

FIGS. 2A-C are screen shots of a user interface with variable size user input areas;

FIG. 3 is a screen shot of another user interface with variable size user input areas; and

FIG. 4 is a flow chart of an embodiment of the inventive method.

Like reference numbers in the various drawings indicate like elements.

### DETAILED DESCRIPTION

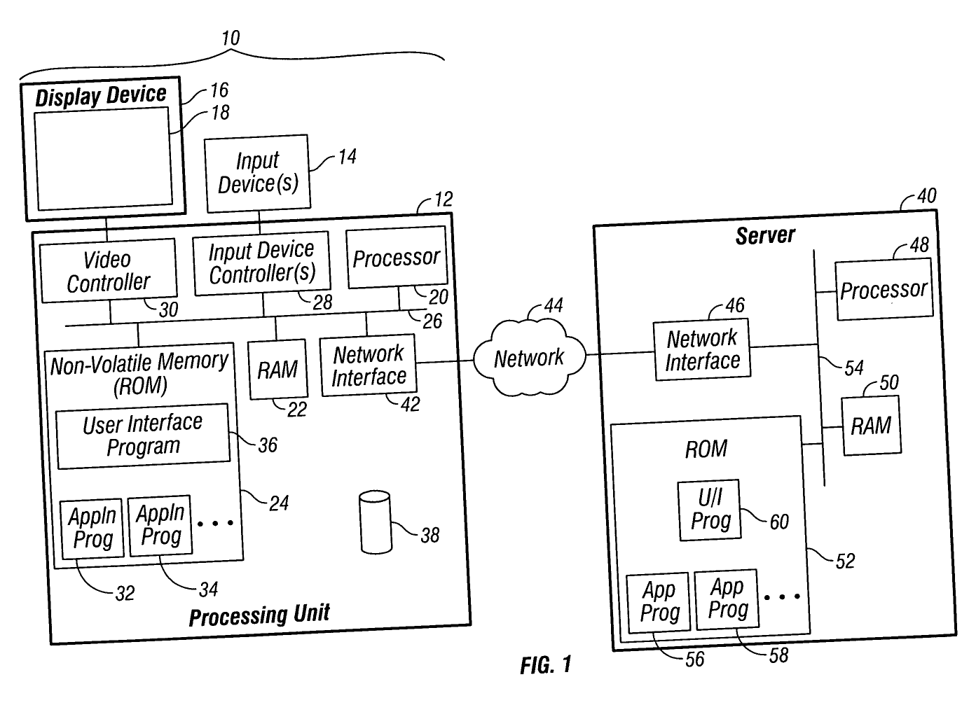

A computer system 10, shown in FIG. 1, includes a processing unit 12, one or more input devices 14, and a display device 16 that may present displays to a user. The display device 16 has a screen 18 upon which the displays may appear. The system 10 is capable of displaying user interfaces with variable size user input areas on the display device 16 as will be described below.

The processing unit 12 includes a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The computer system 10 is not limited to a personal computer, but could instead include a personal digital assistant, a terminal, a workstation, or other such device.

ROM 24, as is conventional, may provide non-volatile data storage for various application programs 32, 34, etc. Programs 32 and 34 have program instructions that may be loaded into RAM 22 during operation. Processor 20 may then execute the program instructions, as required, to perform particular program functions. Also stored in ROM 24 is a user interface program 36 that may be designed to work in concert with each of the application programs 32, 34, etc. This is conceptually depicted in FIG. 1 by the user interface program 36 being shown as a layer on top of the application programs 32, 34, etc.

With such a design, user interface program modules common to several application programs need not be duplicated in each of the application programs. In addition, such a design may enable a common “look-and-feel” to the user interface for the different program applications 32, 34, etc. The user interface program 36 may create a display in accordance with the invention to be presented to a user on screen 18 of display device 16. The user may interact with the display by providing input using an input device 14, such as a mouse, keyboard, light pen, touchpad, joystick, etc. The user interface program 36 may use the received input to take appropriate actions, such as updating the display, creating a new display, interacting with applications programs 32 and/or 34, accessing a database 38, or accessing server 40 (described below), to list just a few examples. In other implementations, the user interface program 36 need not be a common program or module for more than one program application. Also, the components just described could be combined or separated in various manners, and could be stored in various manners, such as on various non-volatile storage medium.

Also shown in FIG. 1 is server 40. The computer system 10 may access server 40 to run applications residing on the server 40. The computer system 10 may do so by using a network interface 42 connected to its data bus 26 to access a network 44. Network 44 may be, for example, a local area network (LAN), wide area network (WAN), or a network allowing the computer system 10 and the server 40 to be part of the Internet. As is conventional, the server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, etc., as well as a common user interface program 60 for the application programs 56, 58, etc. User interface program 60 may operate similarly to user interface program 36. For example, the user interface program 60 may provide variable size user input areas for display on screens of client devices, such as system 10. Any of the entities described above in the server ROM 52 could alternatively be located in a separate server, database, or computer system.

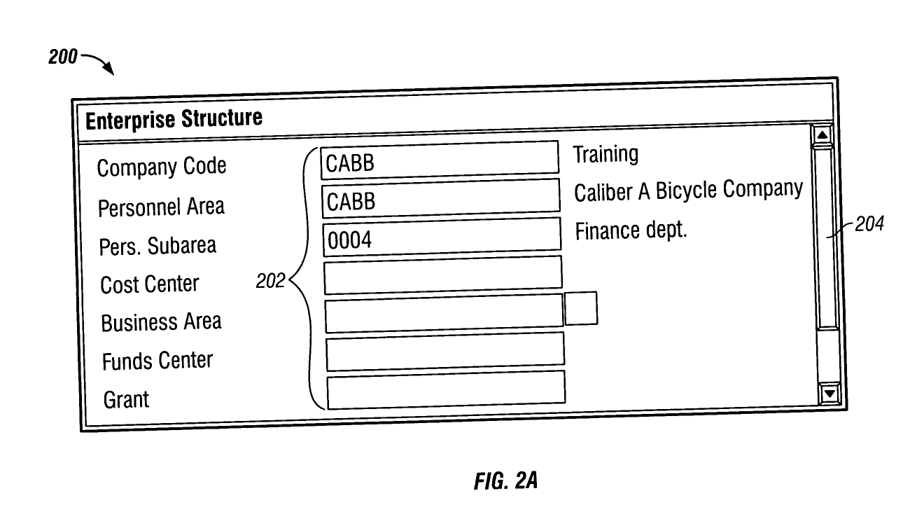

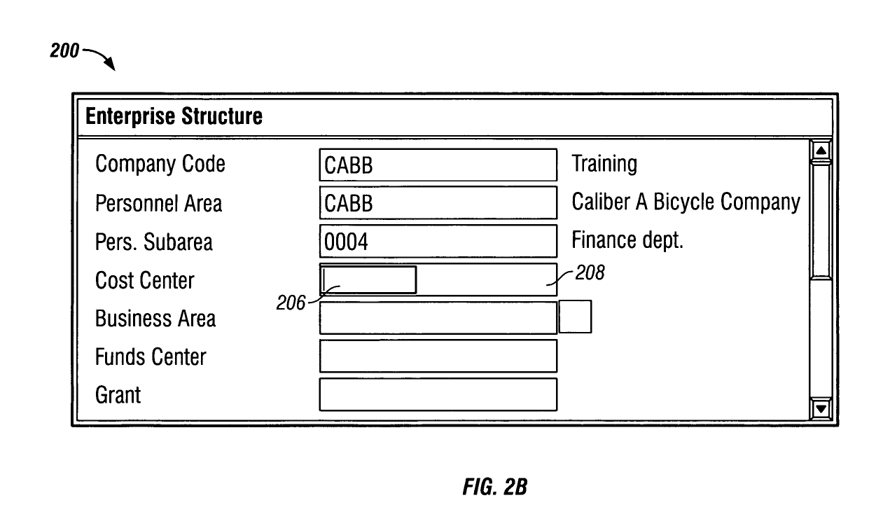

FIGS. 2A-C are examples of screens that the user interface program 36 or 60 can display on the display device 16. Particularly, these screens include variable size user input areas as will now be described with reference first to FIG. 2A. A panel 200 is a user interface view component where the user can enter data in a form. For this purpose, the panel 200 has a number of user input areas 202, some of which already contain data in this example. Although the user input areas 202 are all equally wide in this example, each area may have a limit on the amount of data that can be entered into the data field with which the particular area is associated, and this limit may be different from the limit for others of the input areas 202. The limits are likely unknown to a user that is not familiar with this particular panel 200. To the right of the user input areas 202 is a slide bar 204 (here partially visible), with which the user can move the panel 200 up or down.

To enter data in the user input areas 202, the user first puts the particular area in focus, for example by using a pointer device to click in the area, or otherwise moving the cursor into the area. In FIG. 2B, for example, the user has placed the cursor in user input area 206. It can be seen that an area 208 adjacent to the user input area 206 is highlighted in a different shade than it was in FIG. 2A. The user input area 206 is displayed with a specified length visible against the contrast of the portion area 208. This gives the user visual feedback both of which user input area has focus (i.e. where the cursor is) and how much data can be entered in the data field. Another way of highlighting the user input area in focus will be described later.

The user input area 206 may initially be displayed with a length based in part on the maximum number of proportional-font characters that can be entered. Thus, if the data field underlying the user input area 206 is limited to 10 characters, the user input area 206 may initially be displayed with a length corresponding to 10 characters of average width. Although the width of individual characters may vary between different proportional fonts, the relations in width between individual characters are usually similar for most fonts. That is, in almost all proportional fonts, the character “i” is one of the narrowest characters and “W” is one of the widest. Other characters, such as “E”, have widths that are about average for the proportional font. The width of 10 average characters gives a good estimate of the length required to fit an input of 10 characters. The user input area 206 therefore may initially be provided with a length corresponding to the maximum number of input characters each having an average width; in this example, the width of 10 “E” characters. The user input area 206 is now ready to accept data input by the user, as indicated by the cursor at the left edge of the user input area 206.

More specifically, the user may enter character(s) in the user input area 206 by specifying them on input device(s) 14, such as on a keyboard. The system 10 receives the user input specifying the character(s) and displays visual representations of the character(s) on the display device 18. The visual representation on the display device 18 of a character that the user entered through a keyboard is sometimes conventionally referred to as a character “entered” by the user.

FIG. 2C shows the panel 200 after the user has entered the characters “Example”. At regular intervals during character entry, the user interface program monitors the cumulative size of the entered characters. Based on this size and on the remainder of the possible data input, the size of the user input area 206 is adjusted. Preferably, the system makes this evaluation and adjustment after each entered character. In the FIG. 2C example, this would first be done after the user entered the character “E”, and then after each subsequent character of the word “Example”. The user interface program determined the width of the character “E” and adjusted the user input area 206 to a new size based on this width and the remaining number of characters that could be entered in the data field. In this example, the adjusted size after receiving the character “E” is equal to the width of the character “E” plus nine times the average character width. If “E” has the average character width, the size of user input area 206 is equal to its initial size, which had a width of ten average characters.

For entered characters of non-average width, however, the adjusted size will differ from before the character was entered. That is, if the entered character is narrower than the average character (or whatever character width the initial size is based on), the adjusted size will be shorter than before the character was entered. If the entered character is wider than the average character (or another base character), then the adjusted size will be longer than before the character was entered. The evaluation and adjustment may be done similarly for each subsequent input character, up to the maximum number. Similar steps may be performed when the user begins typing in a user input area that already contains some data, assuming that the data field has not reached its input limit.

It may, however, be desirable to treat the last character space of user input area 206 differently than the preceding ones. That is, when only one more character can be entered in the area, it has been found advantageous to show the user the maximum space available for it. In this example, this would occur if the user had entered nine characters, because the data field to which the user input area corresponds in this example has a 10-character maximum input. After the second last character is entered (the ninth in this example), the user interface program displays the user input area with a size equal to the width of the widest character plus the width of the received characters displayed in the user input area. In this example, the adjusted size is the cumulative width of the nine displayed characters plus the width of the widest character. If the user enters a last character (the tenth in this example), the user interface program again determines the width of all entered characters and adjusts the size of the user input area accordingly. That is, after the last of the 10 characters is entered, the user input area 206 is adjusted to a length corresponding to the cumulative width of all entered characters. The area then has a length such that it is entirely filled with characters, which gives the user a strong visual clue that no more data can be input.

As already mentioned, the average character width is only one example of the many character widths that can be selected as the base width for determining the area size. As another example, it would be possible to use a character with extreme width as the base character, such as the widest or narrowest character. This may, however, have undesirable effects. For example, assume that the initial size of the user input area were ten times the narrowest character, possibly the character “i”. This would make the user input area look relatively small for the amount of characters that can actually be entered. Moreover, the system would make the area longer for every input character that is wider than “i”, which many of them may be. To some extent this counteracts the purpose of giving visual feedback to the user of how much data can be entered into the area, because if the user sees the field becoming longer with almost every input character, there is no indication of how long it can get. Analogously, if the initial width were based on a multiple of the widest character, the user input area would be made shorter for many of the entered characters. Again, the user has no clear indication of how much data can be entered. Nonetheless, there may be good reasons to use non-average base widths in some applications.

The user input area may be adjusted similarly if the user deletes data from the area. After a character is removed, the field may be adjusted to a size corresponding to the width of any remaining characters in the field plus the width of the remaining possible input characters having a selected character width, such as the average width.

In the above examples and in the accompanying FIGS. 2A-C, the size of a particular one of the user input areas 202 is not made visible until the field has focus. In other embodiments, the size of the user input areas may be visible whether or not the areas have focus. That is, before the system receives any character(s) from the user that is to be displayed, the user input area may be displayed with its initial (unadjusted) size whether or not the area has focus. Similarly, if data has been entered in an area and its size has been adjusted, the adjusted user input area may remain visible after the field no longer has focus.

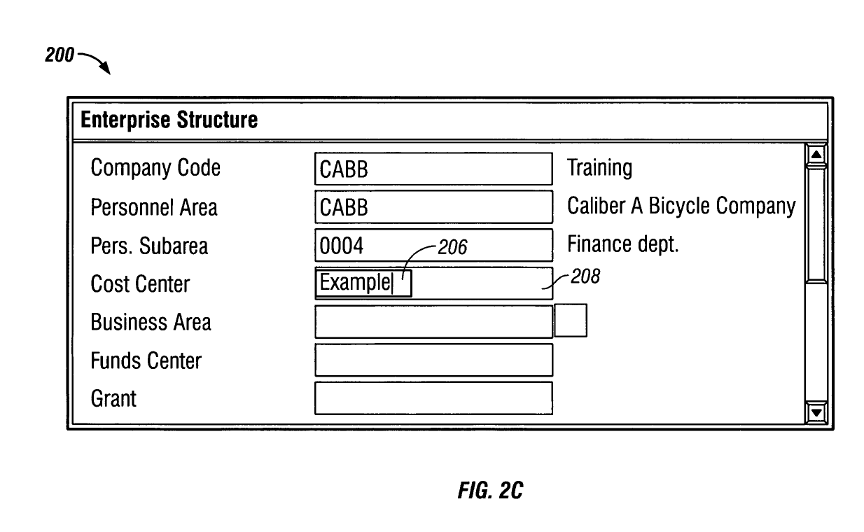

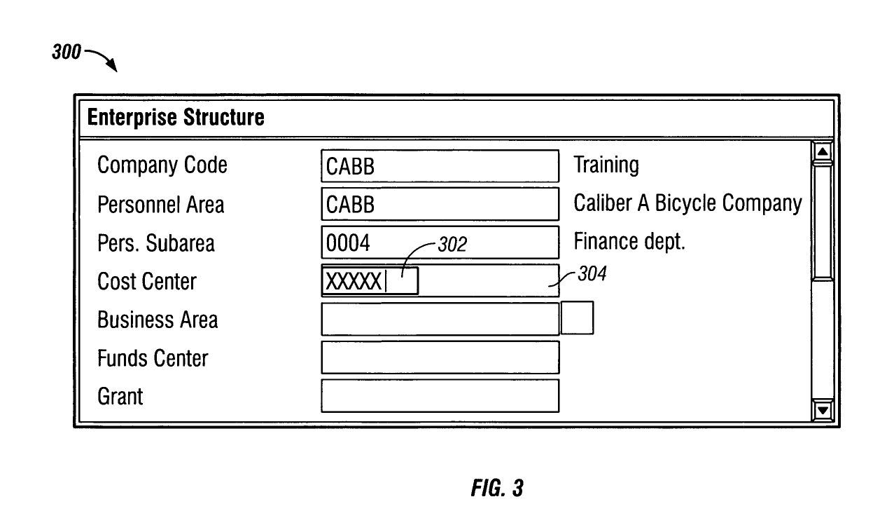

The particular layout of the user input area 206 shown in FIGS. 2A-C is not the only possible layout. FIG. 3 shows an exemplary panel 300 where the shading of a user input element 302 with an adjacent area 304 is applied oppositely compared to the earlier examples. That is, the user input area 302 is shaded when it has focus, and the area 304 remains the same shade as before the user input area 302 was put in focus (compare the surrounding user input areas). When the user types characters into the system for display in user input area 302, its size is adjusted depending on the width of the entered characters and the remaining possible data input.

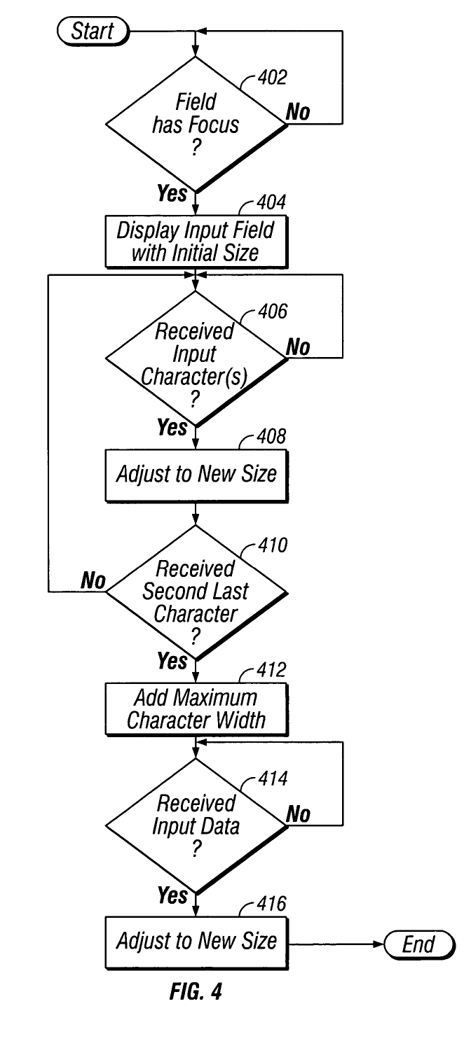

FIG. 4 is an embodiment of an inventive method that may be performed by the user interface program, for example as described above with reference to FIGS. 2A-C. The method begins at step 402 by determining whether a particular user input area has focus. If the area has focus, the method proceeds to step 404, where the user input area is displayed with an initial size. This is similar to FIG. 2B, where the user input area 206 was displayed with an initial size based on the maximum number of characters for the field and the width of an average character.

In step 406, the system determines whether any user input has been received that specifies character(s) to be displayed by visual representation(s) in the user input area. As described above, the adjustment of input area width can be done at different intervals, such as after each entered character. When the amount of data required in step 406 (such as a single character) has been received, the method in step 408 adjusts the user input area to a new size. The new size may be equal to the total width of the received character(s) plus the width of the characters remaining for the user input area having an average width. The new size may be different from, or the same as, the size before the character was received. As long as the second last character of those that can be entered in the area has not been received (step 410), the method returns to step 406. In FIG. 2C, this was done after each entered character of the word “Example”.

When the second last character has been received, however, this method instead adds the maximum character width to make extra room at the end of the characters input in the area (step 412). If the user enters one more character (step 414), the system adjusts the user input area to a new size in step 416. As described above, this new size may be equal to the total width of all the received characters displayed in the user input area.

A system using variable size user input areas may offer various advantages compared to systems with fixed size user input areas. To initially display the user input area with a size corresponding to the maximum number of input characters having average width helps the user estimate how many characters can be input into the data field. Moreover, adjusting the size of the user input area after receipt of input data keeps this visual feedback current. For example, the situation may be avoided that the user reaches the limit number of input characters while there seems to be space left before the end of the user input area, or that the string of entered characters is too wide to be displayed within the user input area. This is because the user input area is regularly adjusted to a new size that depends on the input character(s) and the remainder of characters that can be entered into the user input area.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of displaying a user input area within a computer user interface wherein the user input area corresponds to a data field having a specified number of characters, the method comprising:
displaying the user input area having a size that visually indicates to a user that the user input area will accommodate therein visual representations of the specified number of characters;
upon receipt of a user input specifying a character to be included in the data field, displaying within the user input area a visual representation of the input character in a proportional font; and
displaying the user input area having a size that visually indicates to the user that the user input area will accommodate therein visual representations of a remaining number of the specified number of characters.

2. The method of claim 1, wherein the user input area is displayed only when the user input area has focus.

3. The method of claim 1, wherein the user input area contains a character before the user input specifying the character is received.

4. The method of claim 1, wherein the user input area is empty when the input specifying the character is received, and wherein the user input area size then is equal to the specified number of characters times a selected character width.

5. The method of claim 4, wherein the selected character width is an average width of characters.

6. The method of claim 1, wherein the size of the user input area after the specified character is displayed equals the width of the displayed character plus the remaining number of the specified number of characters times a selected character width.

7. The method of claim 1, wherein the size of the user input area is adjusted after each character that is received.

8. The method of claim 1, further comprising adjusting the size of the user input area differently after receiving a second last character of the specified number of characters.

9. The method of claim 8, further comprising adjusting the user input area, after receiving the second last character, to equal a cumulative width of all characters displayed in the user input area plus a selected character width.

10. The method of claim 9, wherein the selected character width is a maximum width of characters.

11. The method of claim 1, further comprising adjusting the size of the user input area after receiving the specified number of characters, to equal a cumulative width of the characters displayed in the user input area.

12. The method of claim 1, wherein a user input specifying a character to be removed from the data field is received, further comprising displaying the user input area without the removed character, the user input area having a size equal to a cumulative width of any characters displayed in the user input area plus the remaining number of the specified number of characters times a selected character width.

13. A computer program product containing executable instructions for displaying a user input area within a computer user interface wherein the user input area corresponds to a data field having a specified number of characters, the instructions when executed causing a processor to:
display the user input area having a size that visually indicates to a user that the user input area will accommodate therein visual representations of the specified number of characters;
upon receipt of a user input specifying a character to be included in the data field, display within the user input area a visual representation of the input character in a proportional font; and
display the user input area having a size that visually indicates to the user that the user input area will accommodate therein visual representations of a remaining number of the specified number of characters.

14. The computer program product of claim 13, wherein the size of the user input area after displaying the input character equals the width of the character plus the remaining number of the specified number of characters times a selected character width.

15. The computer program product of claim 13, wherein the remaining number of the specified number of characters is received in the user input area, further comprising instructions that when executed cause the processor to:
display the user input area with a size equal to a cumulative width of the displayed specified number of characters in the user input area.

16. The computer program product of claim 13, further comprising instructions that when executed cause the processor to:
adjust the size of the user input area differently after receiving a second last character of the specified number of characters.

17. The computer program product of claim 16, further comprising instructions that when executed cause the processor to:
adjust the user input area, after receiving the second last character, to a size that is equal to a width of all characters displayed in the user input area plus a selected character width.

18. The computer program product of claim 17, wherein the selected character width is a maximum width of characters.
